(19) United States
(12) Patent Application Publication
(10) Pub. No.: US 2015/0181285 A1
(43) Pub. Date: Jun. 25, 2015

(54) Media Playback Method, Control Point, and Terminal

(71) Applicant: Huawei Device Co., Ltd., Shenzhen (CN)

(72) Inventors: Yajun Zhang, Shenzhen (CN); Yunsheng Kuang, Shenzhen (CN); Zhenwei Shan, Shenzhen (CN); Yu Zhu, Shenzhen (CN)

(21) Appl. No.: 14/634,995

(22) Filed: Mar. 2, 2015

Related U.S. Application Data
(63) Continuation of application No. PCT/CN2012/080962, filed on Sep. 4, 2012.

(51) Int. Cl. H04N 21/436; H04N 21/45; H04N 21/442; H04N 21/435; H04N 21/426; H04N 21/4363

(52) U.S. Cl. CPC H04N 21/43615; H04N 21/42684; H04N 21/4363; H04N 21/44204; H04N 21/435; H04N 21/4516

(57) ABSTRACT

The present invention provides a media playback method, where a control point controls a media playback device to play a first media, where the control point acquires a resolution supported by the media playback device; acquires, according to the resolution supported by the media playback device, address information of the first media to be sent to the media playback device; and sends the address information of the first media to the media playback device, so that the media playback device plays the first media according to the address information of the first media. Embodiments of the present invention are advantageous because the control point can select, according to the resolution supported by the media playback device, a media resource of a corresponding resolution, and push the media resource of the corresponding resolution to the media playback device.

### CROSS-REFERENCE TO RELATED APPLICATION

This application is a continuation of International Application No. PCT/CN2012/080962, filed on Sep. 4, 2012, which is hereby incorporated by reference in its entirety.

### TECHNICAL FIELD

The present invention relates to the field of communications technologies, and in particular, to a media playback method, a control point, and a terminal.

### BACKGROUND

To discover and control different devices in a home network, support for the universal plug and play (UPnP) protocol is found in increasing home network devices. In accordance with the UPnP protocol, a user controls a home network device by using a control point in a home network device; and by invoking a related control command of the home network device, the control point acquires information about the home network device and implements control over the home network device.

Currently, there is no solution whereby a network side in a home network can dynamically select a to-be-played media whose resolution matches with a device-supported resolution.

### SUMMARY

Embodiments of the present invention provide a media playback method, a control point, and a terminal.

According to a first aspect of the present invention, a media playback method is used to push a second media to a second device when a first device plays a first media, where the first device and the second device are in a same local area network; and the method includes acquiring, by the first device, a resolution supported by the second device; acquiring, by the first device according to the resolution supported by the second device, address information of the second media to be sent to the second device, where content of the second media is the same as content of the first media, and the second device supports a resolution of the second media; and sending, by the first device, the address information of the second media to the second device, so that the second device plays the second media according to the address information of the second media.

In a first possible implementation of the first aspect, the acquiring, by the first device according to the resolution supported by the second device, address information of the second media to be sent to the second device includes acquiring, by the first device, media description information from a directory server, where the media description information includes resolution information and address information of a media whose content is the same as the content of the first media; and determining, by the first device according to the resolution supported by the second device and resolution information in the media description information, a media whose resolution is the same as a highest resolution supported by the second device to be the second media, and acquiring the address information of the second media from the media description information.

In a second possible implementation of the first aspect, the acquiring, by the first device according to the resolution supported by the second device, address information of the second media to be sent to the second device includes sending, by the first device, the resolution supported by the second device to a directory server, so that the directory server determines a media whose resolution is the same as a highest resolution supported by the second device to be the second media that is to be pushed to the second device; and receiving, by the first device, the address information of the second media from the directory server.

With reference to the first aspect, the first possible implementation of the first aspect, or the second possible implementation of the first aspect, in a third possible implementation, if a network bandwidth of the second device is less than a network bandwidth required to play the second media, address information of the first media is sent to the second device, so that the second device plays the first media; or address information of a third media is sent to the second device, so that the second device plays the third media, where content of the third media is the same as the content of the first media, and a network bandwidth required to play the third media is less than or equal to the network bandwidth of the second device.

With reference to the first possible implementation of the first aspect or the second possible implementation of the first aspect, in a fourth possible implementation, if there does not exist the second media whose resolution is the same as the highest resolution supported by the second device, address information of a fourth media is sent to the second device, so that the second device plays the fourth media according to the address information of the fourth media, where content of the fourth media is the same as the content of the first media, and a resolution of the fourth media is lower than the highest resolution supported by the second device.

With reference to the first aspect, or any of the first possible implementation to the fourth possible implementation of the first aspect, in a fifth possible implementation, the first device sends, to the second device, information about a current playback progress where the first device stops playing the first media, so that the second device starts to play the second media, the first media, the third media, or the fourth media from where the current playback progress stops.

With reference to the fifth possible implementation of the first aspect, in a sixth possible implementation, the information about the current playback progress where the first device stops playing the first media includes a current timestamp of the first-media playback by the first device.

According to a second aspect of the present invention, a media playback method is used by a control point to control a media playback device to play a first media, and the method includes acquiring, by the control point, a resolution supported by the media playback device; acquiring, by the control point according to the resolution supported by the media playback device, address information of the first media to be sent to the media playback device, where the media playback device supports a resolution of the first media; and sending, by the control point, the address information of the first media to the media playback device, so that the media playback device plays the first media according to the address information of the first media.

In a first possible implementation of the second aspect, the acquiring, by the control point according to the resolution supported by the media playback device, address information of the first media to be sent to the media playback device includes acquiring, by the control point, media description information from a directory server, where the media description information includes resolution information and address information of a media whose content is the same as content of the first media; and determining, by the control point according to the resolution supported by the media playback device and resolution information in the media description information, a media whose resolution is the same as a highest resolution supported by the media playback device to be the first media, and acquiring the address information of the first media from the media description information.

In a second possible implementation of the second aspect, the acquiring, by the control point according to the resolution supported by the media playback device, address information of the first media to be sent to the media playback device includes sending, by the control point, the resolution supported by the media playback device to a directory server, so that the directory server determines a media whose resolution is the same as a highest resolution supported by the second device to be the second media that is to be pushed to the second device; and receiving, by the control point, the address information of the first media from the directory server.

With reference to the second aspect, the first possible implementation of the second aspect, or the second possible implementation of the second aspect, in a third possible implementation, if a network bandwidth of the media playback device is less than a network bandwidth required to play the first media, address information of a second media is sent to the media playback device, so that the media playback device plays the second media, where content of the second media is the same as the content of the first media, and a network bandwidth required to play the second media is less than or equal to the network bandwidth of the media playback device.

With reference to the first possible implementation of the second aspect or the second possible implementation of the second aspect, in a fourth possible implementation, if there does not exist the first media whose resolution is the same as the highest resolution supported by the media playback device exists, address information of a third media is sent to the media playback device, so that the media playback device plays the third media according to the address information of the third media, where content of the third media is the same as the content of the first media, and a resolution of the third media is lower than the highest resolution supported by the media playback device.

According to a third aspect of the present invention, a control point is configured to push a second media to a second device when a first device plays a first media, where the first device and the second device are in a same local area network; and the control point includes a receiving unit, an acquiring unit, and a sending unit, where the receiving unit is configured to receive capability information of the second device; the acquiring unit is configured to parse the capability information of the second device to acquire a resolution supported by the second device; and acquire, according to the resolution supported by the second device, address information of the second media to be sent to the second device, where content of the second media is the same as content of the first media, and the second device supports a resolution of the second media; and the sending unit is configured to send the address information of the second media to the second device, so that the second device plays the second media according to the address information of the second media.

In a first possible implementation of the third aspect, the receiving unit is further configured to acquire media description information from a directory server, where the media description information includes resolution information and address information of a media whose content is the same as the content of the first media; and the acquiring unit is configured to determine, according to the resolution supported by the second device and resolution information in the media description information, a media whose resolution is the same as a highest resolution supported by the second device to be the second media, and acquire the address information of the second media from the media description information.

In a second possible implementation of the third aspect, the sending unit is further configured to send the resolution supported by the second device to a directory server, so that the directory server determines a media whose resolution is the same as a highest resolution supported by the second device to be the second media that is to be pushed to the second device; and the receiving unit is further configured to receive the address information of the second media from the directory server.

With reference to the third aspect, the first possible implementation of the third aspect, or the second possible implementation of the third aspect, in a third possible implementation, the control point further includes a bandwidth comparing unit, where the bandwidth comparing unit is configured to determine whether a network bandwidth of the second device is less than a network bandwidth required to play the second media; and the sending unit is further configured to, when the network bandwidth of the second device is less than the network bandwidth required to play the second media, send address information of the first media to the second device, so that the second device plays the first media; or send address information of a third media to the second device, so that the second device plays the third media, where content of the third media is the same as the content of the first media, and a network bandwidth required to play the third media is less than or equal to the network bandwidth of the second device.

With reference to the first possible implementation of the third aspect or the second possible implementation of the third aspect, in a fourth possible implementation, the sending unit is further configured to, if there does not exist the second media whose resolution is the same as the highest resolution supported by the second device, send address information of a fourth media to the second device, so that the second device plays the fourth media according to the address information of the fourth media, where content of the fourth media is the same as the content of the first media, and a resolution of the fourth media is lower than the highest resolution supported by the second device.

With reference to the third aspect, or any of the first possible implementation to the fourth possible implementation of the third aspect, in a fifth possible implementation, the sending unit is further configured to send, to the second device, information about a current playback progress where the first device stops playing the first media, so that the second device starts to play the second media, the first media, the third media, or the fourth media from where the current playback progress stops.

According to a fourth aspect of the present invention, a control point is configured to control a media playback device to play a first media; and the control point includes a receiving unit, an acquiring unit, and a sending unit, where the receiving unit is configured to receive capability information of the media playback device; the acquiring unit is configured to parse the capability information of the media playback device to acquire a resolution supported by the media playback device; and acquire, according to the resolution supported by the media playback device, address information of the first media to be sent to the media playback device, where the media playback device supports a resolution of the first media; and the sending unit is configured to send the address information of the first media to the media playback device, so that the media playback device plays the first media according to the address information of the first media.

In a first possible implementation of the fourth aspect, the receiving unit is further configured to acquire media description information from a directory server, where the media description information includes resolution information and address information of a media whose content is the same as content of the first media; and the acquiring unit is configured to determine, according to the resolution supported by the media playback device and resolution information in the media description information to be the first media, a media whose resolution is the same as a highest resolution supported by the media playback device, and acquire the address information of the first media from the media description information.

In a second possible implementation of the fourth aspect, the sending unit is further configured to send the resolution supported by the media playback device to a directory server, so that the directory server determines a media whose resolution is the same as a highest resolution supported by the second device to be the second media that is to be pushed to the second device; and the receiving unit is further configured to receive the address information of the first media from the directory server.

With reference to the fourth aspect, the first possible implementation of the fourth aspect, or the second possible implementation of the fourth aspect, in a third possible implementation, the control point further includes a bandwidth comparing unit, where the bandwidth comparing unit is configured to determine whether a network bandwidth of the media playback device is less than a network bandwidth required to play the first media; and the sending unit is further configured to, when the network bandwidth of the media playback device is less than the network bandwidth required to play the first media, send address information of a second media to the media playback device, so that the media playback device plays the second media, where content of the second media is the same as the content of the first media, and a network bandwidth required to play the second media is less than or equal to the network bandwidth of the media playback device.

With reference to the first possible implementation of the fourth aspect or the second possible implementation of the fourth aspect, in a fourth possible implementation, the sending unit is further configured to, if there does not exist the first media whose resolution is the same as the highest resolution supported by the media playback device exists, send address information of a third media to the media playback device, so that the media playback device plays the third media according to the address information of the third media, where content of the third media is the same as the content of the first media, and a resolution of the third media is lower than the highest resolution supported by the media playback device.

According to a fifth aspect of the present invention, a terminal is configured to control a media playback device to play a first media, and the terminal includes a receiver, a processor, and a sender, where the receiver is configured to receive capability information of the media playback device; the processor is configured to parse the capability information of the media playback device to acquire a resolution supported by the media playback device; and acquire, according to the resolution supported by the media playback device, address information of the first media to be sent to the media playback device, where the media playback device supports a resolution of the first media; and the sender is configured to send the address information of the first media to the media playback device, so that the media playback device plays the first media according to the address information of the first media.

In a first possible implementation of the fifth aspect, the receiver is further configured to acquire media description information from a directory server, where the media description information includes resolution information and address information of a media whose content is the same as content of the first media; and the processor is configured to determine, according to the resolution supported by the media playback device and resolution information in the media description information, a media whose resolution is the same as a highest resolution supported by the media playback device to be the first media, and acquire the address information of the first media from the media description information.

In a second possible implementation of the fifth aspect, the sender is further configured to send the resolution supported by the media playback device to a directory server, so that the directory server determines a media whose resolution is the same as a highest resolution supported by the second device to be the second media that is to be pushed to the second device; and the receiver is further configured to receive the address information of the first media from the directory server.

With reference to the fifth aspect, the first possible implementation of the fifth aspect, or the second possible implementation of the fifth aspect, in a third possible implementation, the processor is further configured to determine whether a network bandwidth of the media playback device is less than a network bandwidth required to play the first media; and the sender is further configured to, when the network bandwidth of the media playback device is less than the network bandwidth required to play the first media, send address information of a second media to the media playback device, so that the media playback device plays the second media, where content of the second media is the same as the content of the first media, and a network bandwidth required to play the second media is less than or equal to the network bandwidth of the media playback device.

With reference to the first possible implementation of the fifth aspect or the second possible implementation of the fifth aspect, in a fourth possible implementation, the sender is further configured to, if there does not exist the first media whose resolution is the same as the highest resolution supported by the media playback device exists, send address information of a third media to the media playback device, so that the media playback device plays the third media according to the address information of the third media, where content of the third media is the same as the content of the first media, and a resolution of the third media is lower than the highest resolution supported by the media playback device.

With reference to the fifth aspect, or any implementation in the first possible implementation to the fourth possible implementation of the fifth aspect, in a fifth possible implementation, the terminal is a smartphone, a tablet computer, a personal computer, or a smart television.

In the embodiments of the present invention, a second media is pushed to a second device when a first device plays a first media, where the first device and the second device are in a same local area network. The first device acquires a resolution supported by the second device, and acquires, according to the resolution supported by the second device, address information of the second media to be sent to the second device, where content of the second media is the same as content of the first media, and the second device supports a resolution of the second media; and the first device sends the address information of the second media to the second device, so that the second device plays the second media according to the address information of the second media. The embodiments of the present invention is advantageous because the first device can select, according to the resolution supported by the second device, a media resource of a corresponding resolution, and push the media resource of the corresponding resolution to the second device. In this way, a media resource of a suitable resolution is dynamically selected, thereby exploiting a device playback capability and improving device playback quality.

### BRIEF DESCRIPTION OF THE DRAWINGS

To describe the technical solutions in the embodiments of the present invention or in the prior art more clearly, the following briefly introduces the accompanying drawings required for describing the embodiments. The accompanying drawings in the following description show merely some embodiments of the present invention, and a person of ordinary skill in the art may still derive other drawings from these accompanying drawings without creative efforts.

FIG. 1 is a schematic structural diagram of a media playback system in the prior art;

FIG. 2 is a schematic diagram depicting a file organization structure of a directory server in FIG. 1;

FIG. 3 is a flowchart of a media playback method according to an embodiment of the present invention;

FIG. 4 is a flowchart of another media playback method according to an embodiment of the present invention;

FIG. 5 is a signal interaction diagram of a method for pushing a media between a smartphone and a high definition television (HDTV) according to an embodiment of the present invention;

FIG. 6 is a flowchart of another media playback method according to an embodiment of the present invention;

FIG. 7 is a flowchart of another media playback method according to an embodiment of the present invention;

FIG. 8 is a schematic structural diagram of a control point according to an embodiment of the present invention;

FIG. 9 is a schematic structural diagram of another control point according to an embodiment of the present invention; and

FIG. 10 is a schematic structural diagram of another control point according to an embodiment of the present invention.

### DETAILED DESCRIPTION

The following clearly describes the technical solutions in the embodiments of the present invention with reference to the accompanying drawings in the embodiments of the present invention. The described embodiments are merely some but not all of the embodiments of the present invention. All other embodiments obtained by a person of ordinary skill in the art based on the embodiments of the present invention without creative efforts shall fall within the protection scope of the present invention.

For the purpose of the embodiments, the following terms and definitions apply: when it is mentioned, in the embodiments of the present invention, that content of two media is the same, it means that content included in two media resources is the same; ordinal numbers mentioned in the embodiments of the present invention, such as first and second, should be understood as being merely intended to distinguish one entity or operation from another, and unless otherwise stated, the ordinal numbers do not necessarily require or imply that any actual sequence exists between these entities or operations; a terminal mentioned in the embodiments of the present invention may be a smartphone, a tablet computer, a personal computer, a personal digital assistant, a smart television, or the like; and a media playback device mentioned in the embodiments of the present invention may be a smartphone, a tablet computer, an HDTV, a smart television, a digital television, or the like.

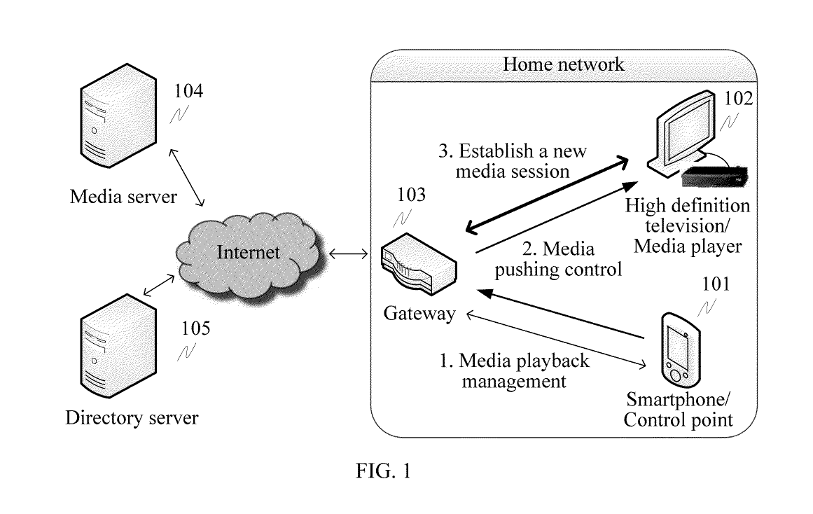

FIG. 1 is a schematic structural diagram of a media playback system in the prior art, where the media playback system includes home devices and network side devices. As shown in FIG. 1, the home devices may include a smartphone 101 and an HDTV 102, the network side devices may include a media server 104 and a directory server 105, and the home devices communicatively connect with the network side devices through a gateway 103 and the Internet.

In the media playback system, the smartphone 101 serves as a media playback device and is configured to play a media; the smartphone 101 may also serve as a control point and is configured to control and manage media playback, where the smartphone 101 may push a media to the HDTV 102, so that the HDTV 102 establishes a media session with the network side and plays a media from the network side. The media server 104 is a platform for providing a multimedia service for a user, and can transmit a video file to a media playback device, so that the user can watch online. The directory server 105 provides media description information for a user, where the media description information may include media playback duration, a media data amount, a resolution, a uniform resource identifier (URI) of a media resource, and the like.

In a typical application scenario of media pushing, the smartphone 101 acquires media resource information from the directory server 105 and chooses to play a standard definition (SD) media; the smartphone 101 receives an SD media stream from the media server 104 to perform playback; during playback, if it is desirable to play the SD media by using the HDTV 102, the SD is pushed to the HDTV 102, and the HDTV 102 receives an SD media stream from the media server 104 to perform playback.

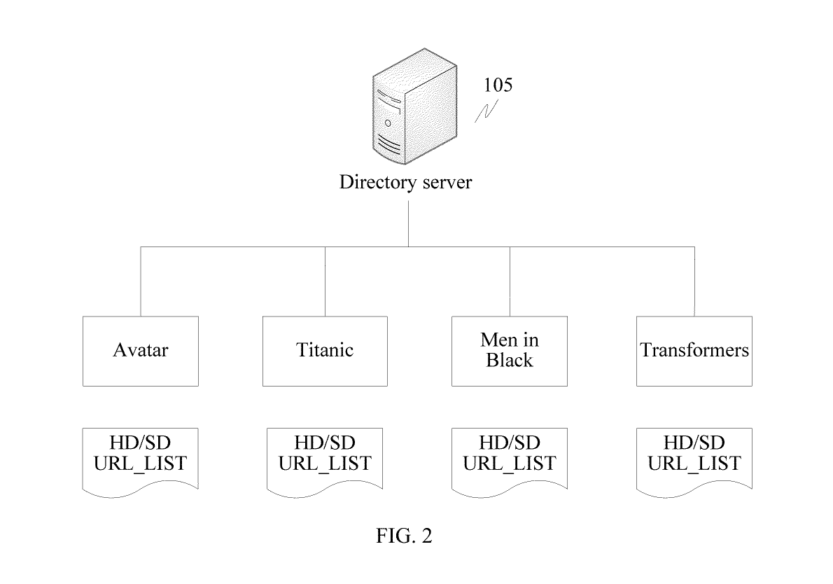

FIG. 2 is a schematic diagram depicting a file organization structure of the directory server in FIG. 1, where the directory server 105 provides, for a user, media description information including media playback duration, a media data amount, a resolution, a media resource URI, and the like.

As shown in FIG. 2, the directory server 105 provides media resources with different resolutions for a same media, and the media resources with different resolutions have different respective URIs. For example, the directory server 105 stores four films such as Avatar, Titanic, Men in Black, and Transformers. The four films are four medias having different content, and each film has two resolutions, that is to say, each film is provided two media resources, one with a resolution of 1920*1080 and the other with a resolution of 1080*720.

URIs of high definition (HD) and SD media resources that have same media content are stored in advance in a same data structure in the directory server 105. For example, as shown in FIG. 2, a video media name serves as a parent node, and each subnode under a parent node is used to store URIs of media resources that have same media content but different resolutions.

For example, the media description information stored in the directory server 105 is as follows:

| | Playback | | Data | |
|---|---|---|---|---|
| Name | duration | Resolution | amount | URI |
| Avatar | 02:36:00 | 1920*1080 | 3512 MB | /HD/1080p/avatar.mp4 |
| Avatar | 02:36:00 | 1280*720 | 2048 MB | /HD/720p/avatar.mp4 |
| Avatar | 02:36:00 | 600*400 | 320M | /SD/400p/avatar.mp4 |

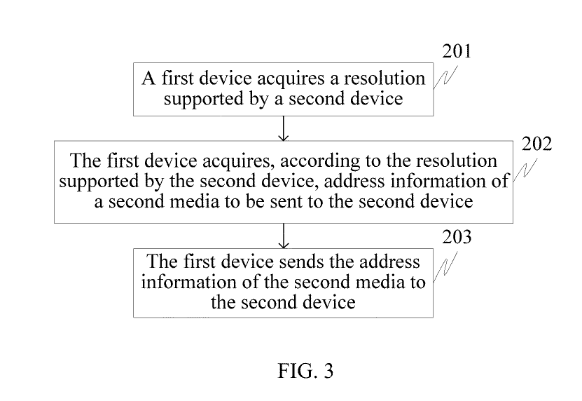

FIG. 3 is a flowchart of a media playback method according to an embodiment of the present invention. The method is used to push a second media to a second device when a first device plays a first media, where the first device and the second device are in a same local area network, and the method includes the following steps.

Step 201: The first device acquires a resolution supported by the second device.

In this embodiment of the present invention, the first device acts as a control point, and the control point can acquire capability information of a device in a network by means of a device discovery procedure. When a device joins a network, the device broadcasts a discovery packet to a standard port such as 239.255.255.250:1900; and the control point listens on the standard port to discover that a new device joins, and parses the broadcast packet to obtain capability information of the device. Similarly, when a new control point joins a network, the control point also broadcasts a discovery packet to a standard port to search for a related device or a related service, and all devices in the network listen on the standard port. When a device among the devices meets a search condition in the discovery packet, the device responds to the control point, so that the control point obtains capability information of the device. By means of the device discovery procedure, the control point can acquire a device description of a device in a network and a description of a service supported by the device.

For example, the discovery packet may be as follows:

NOTIFY * HTTP/1.1
HOST:239.255.255.250:1900
EXT:
CACHE-CONTROL: max-age=1810
LOCATION: http://10.11.85.185:9500/DeviceDescription.xml
NT: urn:schemas-upnp-org:device:MediaRenderer:1
NTS: ssdp:alive
SERVER: Windows NT/5.0, UPnP/1.0, HUAWEI UPnP SDK/1.0
USN: uuid:d1578360-feb3-1167-1000-2c27d742936c::urn:schemas-upnp-org:device:

MediaRenderer:1

The control point can acquire an address http://10.11.85.185:9500/DeviceDescription.xml of a device description file by parsing the foregoing packet, and derive the following device description file from the address:

<?xml version=“1.0”?>
<root xmlns=“urn:schemas-upnp-org:device-1-0”
configId=“configuration number”>
<specVersion>
<major>1</major>
<minor>1</minor>
</specVersion>
<device>
<deviceType>urn:schemas-upnp-org:device:MediaRenderer:1</deviceType>
<friendlyName>HDTV</friendlyName>
<manufacturer>Huawei</manufacturer>
<manufacturerURI>http://www.huawei.com</manufacturerURI>
<modelDescription>long user-friendly title</modelDescription>
<modelName>model name</modelName>
<modelNumber>model number</modelNumber>
<modelURI>URI to model site</modelURI>
<serialNumber>0123456789</serialNumber>
<resolution>

<mode>1920*1080</mode>
<type>progressive/interiace</type>

</resolution>
<UDN>uuid:UUID</UDN>
<UPC>Universal Product Code</UPC>
...
<serviceList>
<service>
<serviceType>urn:schemas-upnp-org:service:ConnectionManager:1</serviceType>
<serviceId>urn:upnp-org:serviceId:ConnectionManager</serviceId>
<SCPDURI>ConnectionManager.xml</SCPDURI>
<eventSubURI>ConnectionManager/Event</eventSubURI>
<controlURI>ConnectionManager/Control</controlURI>
</service>
<service>
<serviceType>urn:schemas-upnp-org:service:AVTransport:1</serviceType>
<serviceId>urn:upnp-org:serviceId:AVTransport</serviceId>
<SCPDURI>AVTransport.xml</SCPDURI>
<eventSubURI>AVTransport/Event</eventSubURI>
<controlURI>AVTransport/Control</controlURI>
</service>
<service>
<serviceType>urn:schemas-upnp-org:service:RenderingControl:1</serviceType>
<serviceId>urn:upnp-org:serviceId:RenderingControl</serviceId>
<SCPDURI>RenderingControl.xml</SCPDURI>
<eventSubURI>RenderingControl/Event</eventSubURI>
<controlURI>RenderingControl/Control</controlURI>
</service>
</serviceList>
</device>
</root>

It can be known by parsing the foregoing device description file that a name of the second device is an HDTV, a highest supported resolution is 1920*1080, and usually the second device is downward compatible with a lower resolution, for example, a resolution of 1080*720 can also be supported.

Step 202: The first device acquires, according to the resolution supported by the second device, address information of the second media to be sent to the second device.

Content of the second media is the same as content of the first media, and the second device supports a resolution of the second media.

In this embodiment of the present invention, the acquiring, by the first device according to the resolution supported by the second device, address information of the second media to be sent to the second device may be performed in the following two manners.

Manner 1: The first device acquires media description information from a directory server, where the media description information includes resolution information and address information of a media whose content is the same as the content of the first media; and the first device determines, according to the resolution supported by the second device and resolution information in the media description information, a media whose resolution is the same as a highest resolution supported by the second device to be the second media, and acquires the address information of the second media from the media description information.

The control point requests, from the directory server, media description information of a media to be played. The directory server may respond to the request message with a Hypertext Transfer Protocol (HTTP) message, where the HTTP response message at least includes resolution information and address information of the second media. For example, while the first device is playing the first media with a resolution of 600*400, such as the SD film Avatar, the control point requests media description information of Avatar from the directory server; and the HTTP response message may be shown as follows:

HTTP/1.1 200 OK
Server: nginx/0.8.33
Date: Fri, 02 Mar 2012 07:57:43 GMT
Content-Type: application/octet-stream
Transfer-Encoding: chunked
Connection: close
Pragma: No-cache
Cache-Control: no-cache
Expires: Thu, 01 Jan 1970 00:00:00 GMT
<media metadata>

<avatar>
<SD>
<URI>http://220.181.61.229/phone?file=/SD/400p/avatar.mp4</URI>
<time>02:36:00</time>
<size>320 MB</size>
<resolution>
<mode>600*400</mode>
<type>progressive</type>
</resolution>
</SD>
<HD>
<URI>http://220.181.61.229/phone?file=/HD/720p/avatar.mp4</URI>
<time>02:36:00</time>
<size>2048 MB</size>
<resolution>
<mode>1280*720</mode>
<type>progressive</type>
</resolution>
</HD>
<HD>
<URI>http://220.181.61.229/phone?file=/HD/1080p/avatar.mp4</URI>
<time>02:36:00</time>
<size>3512 MB</size>
<resolution>
<mode>1920*1080</mode>
<type>progressive</type>
</resolution>
</HD>
</avatar>

</media metadata>

The response message includes a playback duration, a data amount, a resolution, and a media resource URI of a media requested to play. The control point can learn by parsing the response message that Avatar has three media resources, each with a different resolution. One media resource has a resolution of 600*400, a progressive scanning mode, a data amount of 320 megabytes (M), a playback duration of 02:36:00, and a URI of http://220.181.61.229/phone?file=/SD/400P/avatar.mp4; one media resource has a resolution of 1280*720, a progressive scanning mode, a data amount of 2048 M, a playback duration of 02:36:00, and a URI of http://220.181.61.229/phone?file=/HD/720P/avatar.mp4; and one media resource has a resolution of 1920*1080, a progressive scanning mode, a data amount of 3512 M, a playback duration of 02:36:00, and a URI of http://220.181.61.229/phone?file=/HD/1080P/avatar.mp4.

After acquiring resolutions supported by the second device, the control point can build, according to a correspondence between the resolutions supported by the second device and the resolutions of the media resources, a correspondence table between the resolutions supported by the second device and media addresses.

For example, it is already known in the foregoing step that the resolution supported by the HDTV is 1920*1080, and the resolutions of the media resources are 1920*1080, 1280*720, and 600*400. Since playback capability of a device is downward compatible with lower resolutions, the HDTV can play the media resources with the three resolutions, and a correspondence table may be established as follows:

| Device | Device-supported | Media | |
|---|---|---|---|
| name | resolution | resolution | Media URI |
| HDTV | 1920*1080 | 1920*1080 | http://220.181.61.229/phone?file=/HD/1080P/avatar.mp4 |
| HDTV | 1280*720 | 1280*720 | http://220.181.61.229/phone?file=/HD/720P/avatar.mp4 |
| HDTV | 600*400 | 600*400 | http://220.181.61.229/phone?file=/SD/400P/avatar.mp4 |

The control point can determine, by querying the correspondence table, to push Avatar with the resolution of 1920*1080 to the second device; and therefore, acquires the address http://220.181.61.229/phone?file=/HD/1080P/avatar.mp4 of the second media.

Manner 2: The first device sends the resolution supported by the second device to a directory server, so that the directory server determines, a media whose resolution is the same as a highest resolution supported by the second device to be the second media that is to be pushed to the second device; and the first device receives address information of the second media from the directory server.

The control point sends a request message to the directory server to acquire the address information of the second media, where the request message includes the resolution (for example, 1920*1080) supported by the second device; and the directory server determines, according to the resolution supported by the second device, to push the second media with the resolution of 1920*1080 to the second device, obtains an address http://220.181.61.229/phone?file=/HD/1080P/avatar.mp4 of the second media, and sends the address to the first device.

The manners in which the first device acquires, according to the resolution supported by the second device, the address information of the second media to be sent to the second device are not limited to the foregoing two manners. For example, a media whose resolution is one level lower than the highest resolution supported by the second device is determined as the second media, and address information of the second media is acquired. The descriptions provided herein are not intended to be exhaustive or limiting.

Step 203: The first device sends the address information of the second media to the second device, so that the second device plays the second media according to the address information of the second media.

For example, the first device may invoke a SetAVTransportURI( ) command or Seek( ) command defined in an UPnP AVTransport service to send the address http://220.181.61.229/phone?file=/HD/1080P/avatar.mp4 of the second media to the second device, and invoke a Play( ) command to instruct the second device to acquire and play content of the second media.

Further, the SetAVTransportURI( ) command or the Seek( ) command may carry, as an input parameter, information about a current playback progress where the first device stops playing the first media, so that the second device may play the second media from where the current playback progress stops. The information about the current playback progress where the first device stops playing the first media may be a current timestamp of the first-media playback by the first device.

The second device sends a request message HTTP GET, a request message Real Time Streaming Protocol (RTSP) SETUP, or a request message of another protocol to the address according to a protocol (for example, an HTTP, an RTSP/Real-time Transport Protocol (RTP), or another protocol) indicated in the address information of the second media, to request playing media content specified by the address.

In this embodiment of the present invention, a second media is pushed to a second device when a first device plays a first media, where the first device and the second device are in a same local area network. The first device acquires a resolution supported by the second device, and acquires, according to the resolution supported by the second device, address information of the second media to be sent to the second device, where content of the second media is the same as content of the first media, and the second device supports a resolution of the second media; and the first device sends the address information of the second media to the second device, so that the second device plays the second media according to the address information of the second media. This embodiment of the present invention is advantageous because the first device can select, according to the resolution supported by the second device, a media resource of a corresponding resolution, and push the media resource of the corresponding resolution to the second device. In this way, a media resource of a suitable resolution is dynamically selected, thereby exploiting a device playback capability and improving device playback quality.

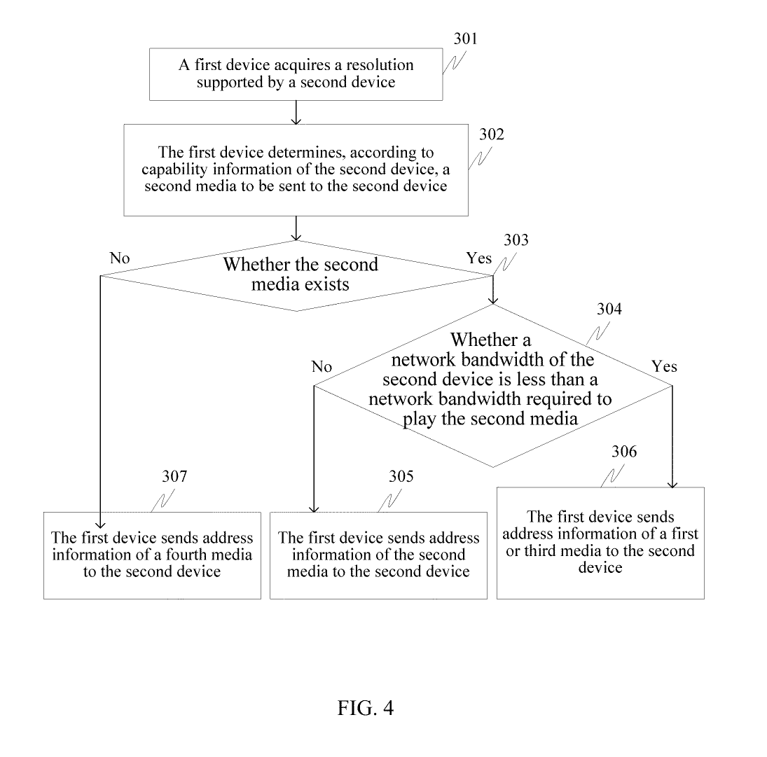

Further, refer to FIG. 4, which is a flowchart of another media playback method according to an embodiment of the present invention. In this embodiment of the present invention, if there exists a second media whose resolution is the same as a highest resolution supported by a second device, a control point determines whether a network bandwidth of the second device is less than a network bandwidth required to play the second media; and if the network bandwidth of the second device is greater than or equal to the network bandwidth required to play the second media, the control point sends address information of the second media to the second device, so that the second device plays the second media; or if the network bandwidth of the second device is less than the network bandwidth required to play the second media, the control point sends address information of the first media or a third media to the second device, so that the second device plays the first media or the third media, where content of the third media is the same as content of the first media, and a network bandwidth required to play the third media is less than or equal to the network bandwidth of the second device. If there does not exist the second media whose resolution is the same as the highest resolution supported by the second device, the control point acquires address information of a fourth media, and sends the address information of the fourth media to the second device, so that the second device plays the fourth media according to the address information of the fourth media, where content of the fourth media is the same as the content of the first media, and a resolution of the fourth media is lower than the highest resolution supported by the second device. As shown in FIG. 4, the method includes the following steps.

Step 301: The first device acquires a resolution supported by the second device.

In this embodiment of the present invention, a specific implementation manner of step 301 is the same as that of step 201, which is not described herein again.

Step 302: The first device determines, according to the resolution supported by the second device, the second media to be sent to the second device.

The first device learns that a resolution of supported by the second device is 1920*1080, and then determines to push the second media with the resolution of 1920*1080 to the second device.

Step 303: The first device determines whether the second media exists.

It is determined whether the second media whose resolution is the same as the highest resolution supported by the second device exists; and if the second media exists, the first device skips to step 304; and if the second media does not exist, the first device skips to step 307.

The step of determining whether the second media exists is performed in the following two manners.

Manner 1: The first device acquires media description information from a directory server, where the media description information includes resolution information and address information of a media whose content is the same as the content of the first media; and the first device determines, according to the resolution supported by the second device and resolution information in the media description information, whether there exists the second media whose resolution is the same as the highest resolution supported by the second device.

Manner 2: The first device sends the resolution supported by the second device to a directory server, so that the directory server determines whether there exists the second media whose resolution is the same as the highest resolution supported by the second device, and sends an indication of whether the second media exists to the first device.

The manners in which the first device acquires, according to the resolution supported by the second device, the address information of the second media to be sent to the second device are not limited to the foregoing two manners. For example, a media whose resolution is one level lower than the highest resolution supported by the second device is determined as the second media, and address information of the second media is acquired. The descriptions provided herein are not intended to be exhaustive or limiting.

Step 304: Determine whether the network bandwidth of the second device is less than the network bandwidth required to play the second media.

If there exists the second media whose resolution is the same as the highest resolution supported by the second device, the first device determines whether the network bandwidth of the second device is less than the network bandwidth required to play the second media; and if the network bandwidth of the second device is greater than or equal to the network bandwidth required to play the second media, the first device skips to step 305; or if the network bandwidth of the second device is less than the network bandwidth required to play the second media, the first device skips to step 306.

For example, the network bandwidth of the second device is 10 megabytes per second (MB/s), a resolution of the second media is 1920*1080, and the network bandwidth required to play the second media is 7.621 MB/s. It can be seen from this example that the network bandwidth of the second device is greater than the network bandwidth required to play the second media, in other words, the network bandwidth of the second device suffices to play the second media with the resolution of 1920*1080. In which case, the first device skips to step 305 to send the address information of the second media to the second device, so that the second device plays the second media according to the address information of the second media.

Alternatively, for another example, the network bandwidth of the second device is 4 MB/s, a resolution of the second media is HD 1920*1080, and the network bandwidth required to play the second media is 7.621 MB/s. It can be seen from this another example that the network bandwidth of the second device is less than the network bandwidth required to play the second media, in other words, the network bandwidth of the second device is insufficient to play the second media with the resolution of 1920*1080. In which case, the first device skips to step 306 to send the address information of the first media to the second device, so that the second device plays the first media according to the address information of the first media; or the first device sends the address information of the third media to the second device, so that the second device plays the third media according to the address information of the third media, where the content of the third media is the same as the content of the first media, and the network bandwidth required to play the third media is less than or equal to the network bandwidth of the second device. For example, a resolution of the third media is 1080*720, and the network bandwidth required to play the third media is 2.847 MB/s; and therefore, the network bandwidth of the second device suffices to play the third media with the resolution of 1080*720.

Step 305: The first device sends the address information of the second media to the second device.

For example, the first device may invoke a SetAVTransportURI( ) command or Seek( ) command defined in an UPnP AVTransport service to send an address http://220.181.61.229/phone?file=/HD/1080P/avatar.mp4 of the second media to the second device, and invoke a Play( ) command to instruct the second device to acquire and play content of the second media.

Step 306: The first device sends the address information of the first media or the third media to the second device.

For example, the first device may invoke a SetAVTransportURI( ) command or Seek( ) command defined in an UPnP AVTransport service to send an address http://220.181.61.229/phone?file=/SD/400P/avatar.mp4 of the first media to the second device, and invoke a Play( ) command to instruct the second device to acquire and play the content of the first media.

Alternatively, the first device may invoke a SetAVTransportURI( ) command or Seek( ) command defined in an UPnP AVTransport service to send an address http://220.181.61.229/phone?file=/HD/720P/avatar.mp4 of the third media to the second device, and invoke a Play( ) command to instruct the second device to acquire and play the content of the third media.

Step 307: The first device sends the address information of the fourth media to the second device.

If there does not exist the second media whose resolution is the same as the highest resolution supported by the second device, the address information of the fourth media is acquired and sent to the second device, so that the second device plays the fourth media according to the address information of the fourth media, where the content of the fourth media is the same as the content of the first media, and the resolution of the fourth media is lower than the highest resolution supported by the second device, for example, the resolution of the fourth media is 1280*720.

The first device may invoke a SetAVTransportURI( ) command or Seek( ) command defined in an UPnP AVTransport service to send an address http://220.181.61.229/phone?file=/HD/720P/avatar.mp4 of the fourth media to the second device, and invoke a Play( ) command to instruct the second device to acquire and play the content of the fourth media.

In this embodiment of the present invention, a second media is pushed to a second device when a first device plays a first media, where the first device and the second device are in a same local area network. The first device acquires a resolution supported by the second device, and acquires, according to the resolution supported by the second device, address information of the second media to be sent to the second device, where content of the second media is the same as content of the first media, and the second device supports a resolution of the second media; and the first device sends the address information of the second media to the second device, so that the second device plays the second media according to the address information of the second media. This embodiment of the present invention is advantageous because the first device can select, according to the resolution supported by the second device, a media resource of a corresponding resolution, and push the media resource of the corresponding resolution to the second device. In this way, a media resource of a suitable resolution is dynamically selected, thereby exploiting a device playback capability and improving device playback quality.

Further, when there does not exist the second media whose resolution is the same as a highest resolution supported by the second device, address information of a fourth media is sent to the second device, so that the second device plays the fourth media according to the address information of the fourth media. In this way, when a media resource with a relatively high resolution does not exist, a media resource with a lower resolution can be selected, which increases the probability of the media playback being successful, exploits a device playback capability, and improves device playback quality.

Further, when a network bandwidth of the second device is less than a network bandwidth required to play the second media, address information of the first media or the third media is sent to the second device, so that the second device plays the first media or the third media. In this way, when the network bandwidth is insufficient to play a media resource with a relatively high resolution, a media resource with a lower resolution can be selected, which increases the probability of the media playback being successful, exploits a device playback capability, and improves device playback quality.

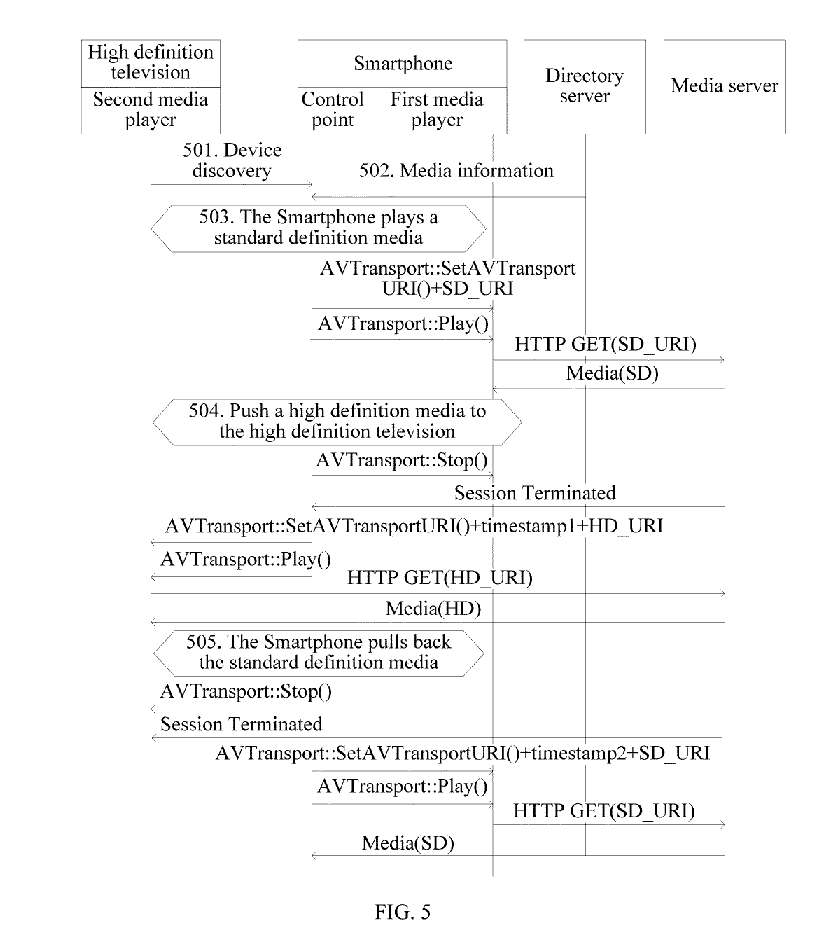

FIG. 5 is a signal interaction diagram of a method for pushing a media between a smartphone and an HDTV according to an embodiment of the present invention. In this embodiment of the present invention, the smartphone serves as both a control point and a first device; the HDTV serves as a second device; a media to be played is Avatar; and during playback of an SD media, the smartphone pushes a high definition media to the HDTV. As shown in FIG. 5, the method includes the following steps.

501: The control point acquires, by means of a device discovery procedure, a resolution supported by the HDTV, where the resolution supported by the HDTV is 1920*1080.

502: The control point acquires resolution information of Avatar from a directory server, where Avatar has three resolutions in total, namely, 1920*1080, 1080*720, and 600*400.

503: The control point controls the smartphone to play the SD media.

The control point sends a SetAVTransportURI( ) command to the smartphone to deliver a uniform resource identifier SD_URI of SD Avatar with the resolution of 600*400 to the smartphone, and sends a Play( ) command to the smartphone to control the smartphone to play the SD Avatar; and the smartphone sends an HTTP GET(SD_URI) command to a media server to acquire a media stream of the SD Avatar to perform playback.

504: The control point pushes the HD media to the HDTV.

According to the resolution of 1920*1080 supported by the HDTV and the resolution information of Avatar, namely, 1920*1080, 1080*720, and 600*400, the control point determines to push Avatar with the resolution of 1920*1080 to the HDTV.

The control point sends a Stop( ) command to the smartphone to stop playing the SD Avatar.

The control point then sends a SetAVTransportURI( ) command to the HDTV to deliver a uniform resource identifier HD_URI of HD Avatar with the resolution of 1920*1080 to the smartphone, and sends a Play( ) command to the HDTV to control the HDTV to play the HD Avatar; and the HDTV sends an HTTP GET(HD_URI) command to the media server to acquire a media stream of the HD Avatar to perform playback.

Further, the control point may further send a current timestamp timestamp1 of the SD Avatar playback by the smartphone to the HDTV, so that the HDTV starts to play the HD Avatar from where the current timestamp timestamp1 indicates.

505: The control point pulls the SD media back to the smartphone for playback.

The control point sends a Stop( ) command to the HDTV to stop playing the HD Avatar.

The control point then sends a SetAVTransportURI( ) command to the smartphone to deliver the uniform resource identifier SD_URI of the SD Avatar with the resolution of 600*400 to the smartphone, and sends a Play( ) command to the smartphone to control the smartphone to play the SD Avatar; and the smartphone sends an HTTP GET(SD_URI) command to the media server to acquire a media stream of the SD Avatar to perform playback.

Further, the control point may further send a current timestamp timestamp2 of the HD Avatar playback by the HDTV to the smartphone, so that the smartphone starts to play the SD Avatar from where the current timestamp timestamp2 indicates.

In this embodiment of the present invention, a smartphone intends to push Avatar to an HDTV for playback while pushing Avatar. The smartphone acquires a resolution of 1920*1080 supported by the HDTV and acquires resolution information of Avatar, including 1920*1080, 1080*720, and 600*400; and the smartphone determines to push Avatar with the resolution of 1920*1080 to the HDTV, and does so after the determination is made. This embodiment of the present invention is advantageous because the smartphone can select, according to the resolution supported by the HDTV, Avatar with a corresponding resolution, and push Avatar with the corresponding resolution to the HDTV. In this way, a media resource of a suitable resolution is dynamically selected, thereby exploiting a playback capability of the HDTV and improving playback quality at the HDTV.

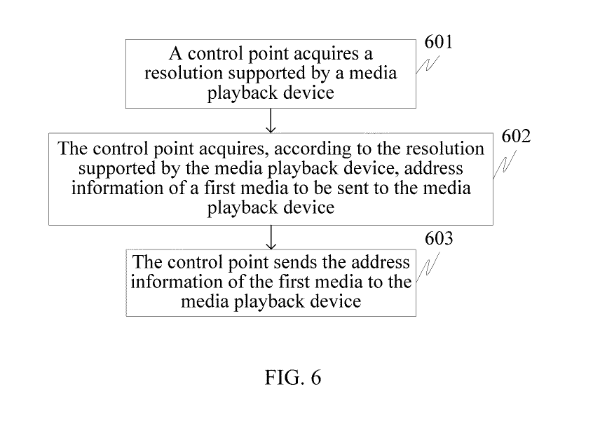

FIG. 6 is a flowchart of a media playback method according to an embodiment of the present invention. The method is used by a control point to control a media playback device to play a first media, and the method includes the following steps.

Step 601: The control point acquires a resolution supported by the media playback device.

In this embodiment of the present invention, the control point can acquire capability information of a device in a network by means of a device discovery procedure. When a device joins a network, the device broadcasts a discovery packet to a standard port such as 239.255.255.250:1900; and the control point listens on the standard port to discover that a new device joins, and parses the broadcast packet to obtain capability information of the device. Similarly, when a new control point joins a network, the control point also broadcasts a discovery packet to a standard port to search for a related device or a related service, and all devices in the network listen on the standard port. When a device among the devices meets a search condition in the discovery packet, the device responds to the control point, so that the control point obtains capability information of the device. By means of the device discovery procedure, the control point can acquire a device description of a device in a network and a description of a service supported by the device.

For example, the discovery packet may be as follows:

NOTIFY * HTTP/1.1
HOST:239.255.255.250:1900
EXT:
CACHE-CONTROL: max-age=1810
LOCATION: http://10.11.85.185:9500/DeviceDescription.xml
NT: urn:schemas-upnp-org:device:MediaRenderer:1
NTS: ssdp:alive
SERVER: Windows NT/5.0, UPnP/1.0, HUAWEI UPnP SDK/1.0
USN: uuid:d1578360-feb3-1167-1000-2c27d742936c::urn:schemas-upnp-org:device:

MediaRenderer:1

The control point can acquire an address http://10.11.85.185:9500/DeviceDescription.xml of a device description file by parsing the foregoing packet, and derive the following device description file from the address:

<?xml version=“1.0”?>
<root xmlns=“urn:schemas-upnp-org:device-1-0”
configId=“configuration number”>
<specVersion>
<major>1</major>
<minor>1</minor>
</specVersion>
<device>
<deviceType>urn:schemas-upnp-org:device:MediaRenderer:1</deviceType>
<friendlyName>HDTV</friendlyName>
<manufacturer>Huawei</manufacturer>
<manufacturerURI>http://www.huawei.com</manufacturerURI>
<modelDescription>long user-friendly title</modelDescription>
<modelName>model name</modelName>
<modelNumber>model number</modelNumber>
<modelURI>URI to model site</modelURI>
<serialNumber>0123456789</serialNumber>
<resolution>

<mode>1920*1080</mode>
<type>progressive/interiace</type>

</resolution>
<UDN>uuid:UUID</UDN>
<UPC>Universal Product Code</UPC>
...
<serviceList>
<service>
<serviceType>urn:schemas-upnp-org:service:ConnectionManager:1</serviceType>
<serviceId>urn:upnp-org:serviceId:ConnectionManager</serviceId>
<SCPDURI>ConnectionManager.xml</SCPDURI>
<eventSubURI>ConnectionManager/Event</eventSubURI>
<controlURI>ConnectionManager/Control</controlURI>
</service>
<service>
<serviceType>urn:schemas-upnp-org:service:AVTransport:1</serviceType>
<serviceId>urn:upnp-org:serviceId:AVTransport</serviceId>
<SCPDURI>AVTransport.xml</SCPDURI>
<eventSubURI>AVTransport/Event</eventSubURI>
<controlURI>AVTransport/Control</controlURI>
</service>
<service>
<serviceType>urn:schemas-upnp-org:service:RenderingControl:1</serviceType>
<serviceId>urn:upnp-org:serviceId:RenderingControl</serviceId>
<SCPDURI>RenderingControl.xml</SCPDURI>
<eventSubURI>RenderingControl/Event</eventSubURI>
<controlURI>RenderingControl/Control</controlURI>
</service>
</serviceList>
</device>
</root>

It can be known by parsing the foregoing device description file that a name of the media playback device is an HDTV, and a highest supported resolution is 1920*1080.

Step 602: The control point acquires, according to the resolution supported by the media playback device, address information of the first media to be sent to the media playback device.

The media playback device supports a resolution of the first media.

In this embodiment of the present invention, the step of acquiring, by the control point according to the resolution supported by the media playback device, address information of the first media to be sent to the media playback device may be performed in the following two manners:

Manner 1: The control point acquires media description information from a directory server, where the media description information includes resolution information and address information of a media whose content is the same as content of the first media; and the control point determines, according to the resolution supported by the media playback device and resolution information in the media description information, a media whose resolution is the same as a highest resolution supported by the media playback device to be the first media, and acquires the address information of the first media from the media description information.

The control point requests, from the directory server, media description information of a media to be played. The directory server may respond to the request message with an HTTP message, where the HTTP response message at least includes resolution information and address information of the first media. For example, the control point requests media description information of Avatar from the directory server, and the HTTP response message may be shown as follows:

HTTP/1.1 200 OK
Server: nginx/0.8.33
Date: Fri, 02 Mar 2012 07:57:43 GMT
Content-Type: application/octet-stream
Transfer-Encoding: chunked
Connection: close
Pragma: No-cache
Cache-Control: no-cache
Expires: Thu, 01 Jan 1970 00:00:00 GMT
<media metadata>

<avatar>
<SD>
<URI>http://220.181.61.229/phone?file=/SD/400p/avatar.mp4</URI>
<time>02:36:00</time>
<size>320 MB</size>
<resolution>
<mode>600*400</mode>
<type>progressive</type>
</resolution>
</SD>
<HD>
<URI>http://220.181.61.229/phone?file=/HD/720p/avatar.mp4</URI>
<time>02:36:00</time>
<size>2048 MB</size>
<resolution>
<mode>1280*720</mode>
<type>progressive</type>
</resolution>
</HD>
<HD>
<URI>http://220.181.61.229/phone?file=/HD/1080p/avatar.mp4</URI>
<time>02:36:00</time>
<size>3512 MB</size>
<resolution>
<mode>1920*1080</mode>
<type>progressive</type>
</resolution>
</HD>
</avatar>

</media metadata>

The response message includes a playback duration, a data amount, a resolution, and a media resource URI of a media requested to play. The control point can learn by parsing the response message that Avatar has three resources for the first media, each with a different resolution. One media resource has a resolution of 600*400, a progressive scanning mode, a data amount of 320 M, a playback duration of 02:36:00, and a URI of http://220.181.61.229/phone?file=/SD/400P/avatar.mp4; one media resource has a resolution of 1280*720, a progressive scanning mode, a data amount of 2048 M, a playback duration of 02:36:00, and a URI of http://220.181.61.229/phone?file=/HD/720P/avatar.mp4; and one media resource has a resolution of 1920*1080, a progressive scanning mode, a data amount of 3512 M, a playback duration of 02:36:00, and a URI of http://220.181.61.229/phone?file=/HD/1080P/avatar.mp4.

After acquiring resolutions supported by the media playback device, the control point can build, according to a correspondence between the resolutions supported by the media playback device and the resolutions of the media resources, a correspondence table between the resolutions supported by the media playback device and media addresses.

For example, it is already known in the foregoing step that the resolution supported by the HDTV is 1920*1080, and the resolutions of the media resources are 1920*1080, 1280*720, and 600*400; since a playback capability of a device is downward compatible with a lower resolution, the HDTV can play the media resources with the three resolutions, and a correspondence table may be established as follows:

| Device | Device-supported | Media | |
|---|---|---|---|
| name | resolution | resolution | Media URI |
| HDTV | 1920*1080 | 1920*1080 | http://220.181.61.229/phone?file=/HD/1080P/avatar.mp4 |
| HDTV | 1280*720 | 1280*720 | http://220.181.61.229/phone?file=/HD/720P/avatar.mp4 |
| HDTV | 600*400 | 600*400 | http://220.181.61.229/phone?file=/SD/400P/avatar.mp4 |

The control point can determine, by querying the correspondence table, to push a video with the resolution of 1920*1080 to the media playback device; and therefore, acquires the address http://220.181.61.229/phone?file=/HD/1080P/avatar.mp4 of the first media.

Manner 2: The control point sends the resolution supported by the media playback device to a directory server, so that the directory server determines, a media whose resolution is the same as a highest resolution supported by the second device to be the second media that is to be pushed to the second device; and the control point receives the address information the first media from the directory server.

The control point sends a request message to the directory server to acquire the address information of the first media, where the request message includes the resolution (for example, 1920*1080) supported by the media playback device; and the directory server determines, according to the resolution supported by the media playback device, to push the first media with the resolution of 1920*1080 to the media playback device, obtains the address http://220.181.61.229/phone?file=/HD/1080P/avatar.mp4 of the first media, and sends the address to the control point.

The manners in which the control point acquires, according to the resolution supported by the second device, the address information of the second media to be sent to the second device are not limited to the foregoing two manners. For example, a media whose resolution is one level lower than the highest resolution supported by the second device is determined as the second media, and the address information of the second media is acquired. The descriptions provided herein are not intended to be exhaustive or limiting.

Step 603: The control point sends the address information of the first media to the media playback device, so that the media playback device plays the first media according to the address information of the first media.

For example, the control point may invoke a SetAVTransportURI( ) command or Seek( ) command defined in an UPnP AVTransport service to send the address http://220.181.61.229/phone?file=/HD/1080P/avatar.mp4 of the first media to the media playback device, and invoke a Play( ) command to instruct the media playback device to acquire and play the content of the first media.

The media playback device sends a request message HTTP GET, a request message RTSP SETUP, or a request message of another protocol to the address according to a protocol (for example, an HTTP, an RTSP/RTP, or another protocol) indicated in the address information of the first media, so as to request playing content of the first media specified by the address.

In this embodiment of the present invention, a control point controls a media playback device to play a first media, where the control point acquires a resolution supported by the media playback device; acquires, according to the resolution supported by the media playback device, address information of the first media to be sent to the media playback device; and sends the address information of the first media to the media playback device, so that the media playback device plays the first media according to the address information of the first media. This embodiment of the present invention is advantageous because the control point can select, according to the resolution supported by the media playback device, a media resource of a corresponding resolution, and push the media resource of the corresponding resolution to the media playback device. In this way, a media resource of a suitable resolution is dynamically selected, thereby exploiting a device playback capability and improving device playback quality.

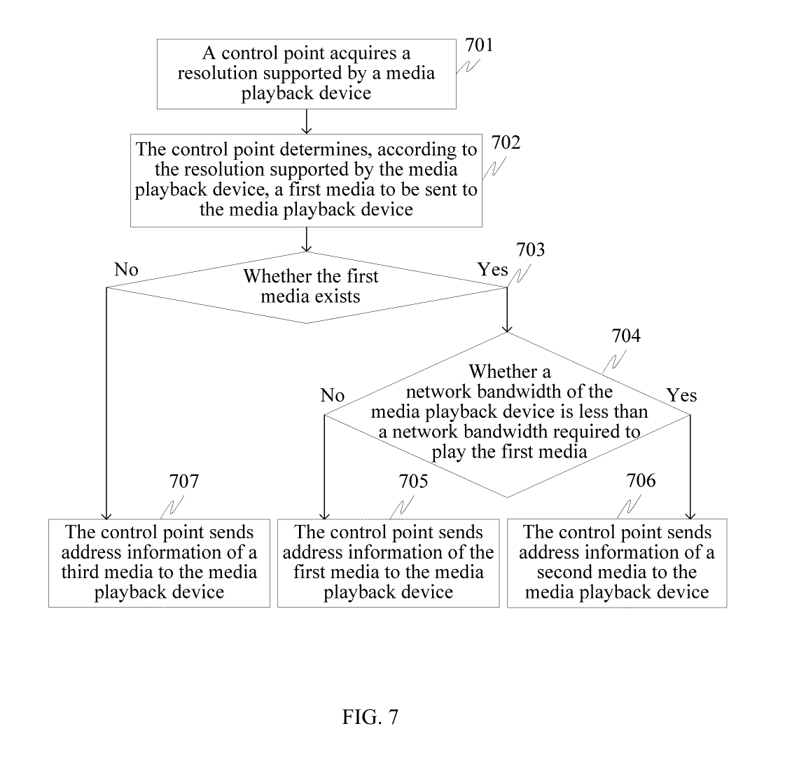

Further, refer to FIG. 7, which is a flowchart of another media playback method according to an embodiment of the present invention. In this embodiment of the present invention, if there exists a first media whose resolution is the same as a highest resolution supported by a media playback device, a control point determines whether a network bandwidth of the media playback device is less than a network bandwidth required to play the first media; and if the network bandwidth of the media playback device is greater than or equal to the network bandwidth required to play the first media, sends address information of the first media to the media playback device, so that the media playback device plays the first media; or if the network bandwidth of the media playback device is less than the network bandwidth required to play the first media, sends address information of a second media to the media playback device, so that the media playback device plays the second media, where content of the second media is the same as that of the first media, and a network bandwidth required to play the second media is less than or equal to the network bandwidth of the second device. If there does not exist the first media whose resolution is the same as the highest resolution supported by the media playback device, the control point acquires address information of a third media, and sends the address information of the third media to the media playback device, so that the media playback device plays the third media according to the address information of the third media, where content of the third media is the same as the content of the first media, and a resolution of the third media is less than the highest resolution supported by the media playback device. As shown in FIG. 7, the method includes the following steps.

Step 701: The control point acquires a resolution supported by the media playback device.

In this embodiment of the present invention, a specific implementation manner of step 701 is the same as that of step 601, which is not described herein again.

Step 702: The control point determines, according to the resolution supported by the media playback device, the first media to be sent to the media playback device.

The control point acquires a resolution of 1920*1080 supported by the media playback device, and then determines to push the first media with the resolution of 1920*1080 to the media playback device.

Step 703: The control point determines whether the first media exists.

It is determined whether there exists the first media whose resolution is the same as the highest resolution supported by the media playback device; and if the first media exists, the control point skips to step 704; or if the first media does not exist, the control point skips to step 707.

The step of determining whether the first media exists is performed in the following two manners.

Manner 1: The control point acquires media description information from a directory server, where the media description information includes resolution information and address information of a media whose content is the same as the content of the first media; and the control point determines, according to the resolution supported by the media playback device and resolution information in the media description information, whether there exists the first media whose resolution is the same as the highest resolution supported by the media playback device.

Manner 2: The control point sends the resolution supported by the media playback device to a directory server, so that the directory server determines whether there exists the first media whose resolution is the same as the highest resolution supported by the media playback device, and sends an indication of whether the first media exists to the control point.

The manners in which the control point acquires, according to the resolution supported by the media playback device, the address information of the first media to be sent to the media playback device are not limited to the foregoing two manners. For example, a media whose resolution is one level lower than the highest resolution supported by the media playback device is determined as the first media, and address information of the first media is acquired. The descriptions provided herein are not intended to be exhaustive or limiting.

Step 704: Determine whether the network bandwidth of the media playback device is less than the network bandwidth required to play the first media.

If there exists the first media whose resolution is the same as the highest resolution supported by the media playback device, the control point determines whether the network bandwidth of the media playback device is less than the network bandwidth required to play the first media; and if the network bandwidth of the media playback device is greater than or equal to the network bandwidth required to play the first media, the control point skips to step 705; or if the network bandwidth of the media playback device is less than the network bandwidth required to play the first media, the control point skips to step 706.

For example, the network bandwidth of the media playback device is 10 MB/s, a resolution of the first media is 1920*1080, and the network bandwidth required to play the first media is 7.621 MB/s. It can be seen from this example that the network bandwidth of the media playback device is greater than the network bandwidth required to play the first media, in other words, the network bandwidth of the media playback device suffices to play the first media with the resolution of 1920*1080. In which case, the control point skips to step 705 to send the address information of the first media to the media playback device, so that the media playback device plays the first media according to the address information of the first media.

For another example, the network bandwidth of the media playback device is 4 MB/s, a resolution of the first media is HD 1920*1080, and the network bandwidth required to play the first media is 7.621 MB/s. It can be seen from this another example that the network bandwidth of the media playback device is less than the network bandwidth required to play the first media, that is, the network bandwidth of the media playback device is insufficient to play the first media with the resolution of 1920*1080. In which case, the control point skips to step 706 to send the address information of the second media to the media playback device, so that the media playback device plays the second media according to the address information of the second media, where the content of the second media is the same as the content of the first media, and the network bandwidth required to play the second media is less than or equal to the network bandwidth of the media playback device. For example, a resolution of the second media is 1080*720, and the network bandwidth required to play the second media is 2.847 MB/s; and therefore, the network bandwidth of the media playback device suffices to play the second media with the resolution of 1080*720.

Step 705: The control point sends the address information of the first media to the media playback device.

For example, the control point may invoke a SetAVTransportURI( ) command or Seek( ) command defined in an UPnP AVTransport service to send an address http://220.181.61.229/phone?file=/HD/1080P/avatar.mp4 of the first media to the media playback device, and invoke a Play( ) command to instruct the media playback device to acquire and play the content of the first media.

Step 706: The control point sends the address information of the second media to the media playback device.

For example, the control point may invoke a SetAVTransportURI( ) command or Seek( ) command defined in an UPnP AVTransport service to send an address http://220.181.61.229/phone?file=/HD/720P/avatar.mp4 of the second media to the media playback device, and invoke a Play( ) command to instruct the media playback device to acquire and play the content of the second media.

Step 707: The control point sends the address information of the fourth media to the media playback device.

If there does not exist the first media whose resolution is the same as the highest resolution supported by the media playback device, the address information of the third media is acquired and sent to the media playback device, so that the media playback device plays the third media according to the address information of the third media, where the content of the third media is the same as the content of the first media, and the resolution of the third media is lower than the highest resolution supported by the media playback device, for example, the resolution of the third media is 1280*720.

The control point may invoke a SetAVTransportURI( ) command or Seek( ) command defined in an UPnP AVTransport service to send an address http://220.181.61.229/phone?file=/HD/720P/avatar.mp4 of the third media to the media playback device, and invoke a Play( ) command to instruct the media playback device to acquire and play the content of the third media.

In this embodiment of the present invention, a control point controls a media playback device to play a first media, where the control point acquires a resolution supported by the media playback device; acquires, according to the resolution supported by the media playback device, address information of the first media to be sent to the media playback device; and sends the address information of the first media to the media playback device, so that the media playback device plays the first media according to the address information of the first media. This embodiment of the present invention is advantageous because the control point can select, according to the resolution supported by the media playback device, a media resource of a corresponding resolution, and push the media resource of the corresponding resolution to the media playback device. In this way, a media resource of a suitable resolution is dynamically selected, thereby exploiting a device playback capability and improving device playback quality.

Further, when there does not exist the first media whose resolution is the same as a highest resolution supported by the media playback device, address information of a third media is sent to the media playback device, so that the media playback device plays the third media according to the address information of the third media. In this way, when a media resource with a relatively high resolution does not exist, a media resource with a lower resolution can be selected, which increases the probability of the media playback being successful, exploits a device playback capability, and improves device playback quality.

Further, when a network bandwidth of the media playback device is less than a network bandwidth required to play the first media, address information of a second media is sent to the media playback device, so that the media playback device plays the second media. In this way, when the network bandwidth is insufficient to play a media resource with a relatively high resolution, a media resource with a lower resolution can be selected, which increases the probability of the media playback being successful, exploits a device playback capability, and improves device playback quality.

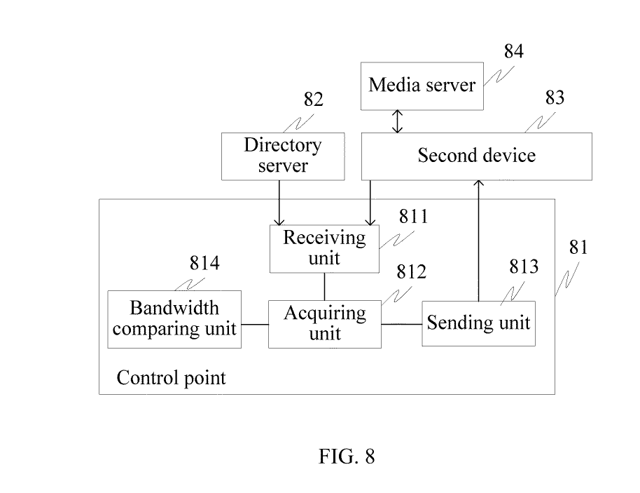

Refer to FIG. 8, which is a schematic structural diagram of a control point 81 according to an embodiment of the present invention. The control point 81 communicatively connects with both a directory server 82 and a second device 83, and the second device 83 communicatively connects with a media server 84. When playing a first media, the control point 81 pushes a second media to the second device 83, where the control point 81 and the second device 83 are in a same local area network. The control point 81 acquires a resolution supported by the second device 83; and acquires, according to the resolution supported by the second device 83, address information of the second media to be sent to the second device 83, where content of the second media is the same as content of the first media, and the second device 83 supports a resolution of the second media; and the first device sends the address information of the second media to the second device 83, so that the second device 83 plays the second media according to the address information of the second media. The control point 81 includes a receiving unit 811 configured to receive capability information of the second device 83; an acquiring unit 812 configured to parse the capability information of the second device 83 to acquire the resolution supported by the second device 83; and acquire, according to the resolution supported by the second device 83, the address information of the second media to be sent to the second device 83, where the content of the second media is the same as the content of the first media, and the second device 83 supports the resolution of the second media; and a sending unit 813 configured to send the address information of the second media to the second device 83, so that the second device 83 plays the second media according to the address information of the second media.

Further, the receiving unit 811 is configured to acquire media description information from the directory server 82, where the media description information includes resolution information and address information of a media whose content is the same as the content of the first media; and the acquiring unit 812 is configured to determine, according to the resolution supported by the second device 83 and resolution information in the media description information, the second media whose resolution is the same as a highest resolution supported by the second device 83, and acquire the address information of the second media from the media description information.

Alternatively, further, the sending unit 813 is configured to send the resolution supported by the second device 83 to the directory server 82, so that the directory server 82 determines the second media that is to be pushed to the second device 83 and whose resolution is the same as a highest resolution supported by the second device 83; and the receiving unit 811 is further configured to receive the address information of the second media from the directory server 82.

Further, the control point 81 includes a bandwidth comparing unit 814, where the bandwidth comparing unit 814 is configured to determine whether a network bandwidth of the second device 83 is less than a network bandwidth required to play the second media; and the sending unit 813 is further configured to, if the network bandwidth of the second device 83 is less than the network bandwidth required to play the second media, send address information of the first media to the second device 83, so that the second device 83 plays the first media; or send address information of a third media to the second device 83, so that the second device 83 plays the third media, where content of the third media is the same as the content of the first media, and a network bandwidth required to play the third media is less than or equal to the network bandwidth of the second device 83.

Further, the sending unit 813 is configured to, if there does not exist the second media whose resolution is the same as the highest resolution supported by the second device 83, send address information of a fourth media to the second device 83, so that the second device 83 plays the fourth media according to the address information of the fourth media, where content of the fourth media is the same as the content of the first media, and a resolution of the fourth media is less than the highest resolution supported by the second device 83.

Further, the sending unit 813 is configured to send, to the second device 83, information about a current playback progress where the first device stops playing the first media, so that the second device 83 starts to play the second media, the first media, the third media, or the fourth media from where the current playback progress stops.

In this embodiment of the present invention, a second media is pushed to a second device when a first device plays a first media, where the first device and the second device are in a same local area network. A control point acquires a resolution supported by the second device, and acquires, according to the resolution supported by the second device, address information of the second media to be sent to the second device, where content of the second media is the same as content of the first media, and the second device supports a resolution of the second media; and the control point sends the address information of the second media to the second device, so that the second device plays the second media according to the address information of the second media. This embodiment of the present invention is advantageous because the control point can select, according to the resolution supported by the second device, a media resource of a corresponding resolution, and push the media resource of the corresponding resolution to the second device. In this way, a media resource of a suitable resolution is dynamically selected, thereby exploiting a device playback capability and improving device playback quality.

Further, when there does not exist the second media whose resolution is the same as a highest resolution supported by the second device, address information of a fourth media is sent to the second device, so that the second device plays the fourth media according to the address information of the fourth media. In this way, when a media resource with a relatively high resolution does not exist, a media resource with a lower resolution can be selected, which increases the probability of the media playback being successful, exploits a device playback capability, and improves device playback quality.

Further, when a network bandwidth of the second device is less than a network bandwidth required to play the second media, address information of the first media or a third media is sent to the second device, so that the second device plays the first media or the third media. In this way, when the network bandwidth is insufficient to play a media resource with a relatively high resolution, a media resource with a lower resolution can be selected, which increases the probability of the media playback being successful, exploits a device playback capability, and improves device playback quality.

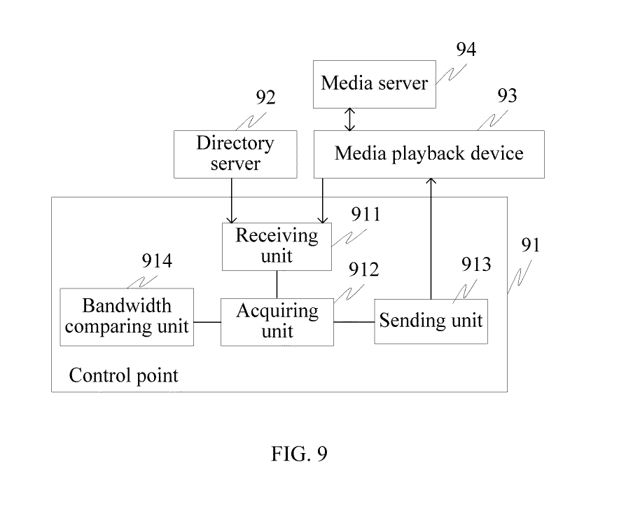

Refer to FIG. 9, which is a schematic structural diagram of another control point 91 according to an embodiment of the present invention. The control point 91 communicatively connects with both a directory server 92 and a media playback device 93, and the media playback device 93 communicatively connects with a media server 94. The control point 91 controls the media playback device 93 to play a first media. The control point 91 acquires a resolution supported by the media playback device 93; and acquires, according to the resolution supported by the media playback device 93, address information of the first media to be sent to the media playback device 93, where the media playback device 93 supports a resolution of the first media; and the control point 91 sends the address information of the first media to the media playback device 93, so that the media playback device 93 plays the first media according to the address information of the first media. The control point 91 includes a receiving unit 911 configured to receive capability information of the media playback device 93; an acquiring unit 912 configured to parse the capability information of the media playback device 93 to acquire the resolution supported by the media playback device 93; and acquire, according to the resolution supported by the media playback device 93, the address information of the first media to be sent to the media playback device 93, where the media playback device 93 supports the resolution of the first media; and a sending unit 913 configured to send the address information of the first media to the media playback device 93, so that the media playback device 93 plays the first media according to the address information of the first media.

Further, the receiving unit 911 is configured to acquire media description information from the directory server, where the media description information includes resolution information and address information of a media whose content is the same as content of the first media; and the acquiring unit 912 is configured to determine, according to the resolution supported by the media playback device 93 and resolution information in the media description information, the first media whose resolution is the same as the resolution supported by the media playback device 93, and acquire the address information of the first media from the media description information.

Alternatively, further, the sending unit 913 is configured to send the resolution supported by the media playback device 93 to the directory server, so that the directory server determines the first media that is to be pushed to the media playback device 93 and whose resolution is the same as the resolution supported by the media playback device 93; and the receiving unit 911 is further configured to receive the address information of the first media from the directory server.

Further, the control point includes a bandwidth comparing unit 914 configured to determine whether a network bandwidth of the media playback device 93 is less than a network bandwidth required to play the first media; and the sending unit 913 is further configured to, when the network bandwidth of the media playback device 93 is less than the network bandwidth required to play the first media, send address information of a second media to the media playback device 93, so that the media playback device 93 plays the second media, where content of the second media is the same as the content of the first media, and a network bandwidth required to play the second media is less than or equal to the network bandwidth of the media playback device 93.

Further, the sending unit 913 is configured to, if there does not exist the first media whose resolution is the same as the resolution supported by the media playback device 93, send address information of a third media to the media playback device 93, so that the media playback device 93 plays the third media according to the address information of the third media, where content of the third media is the same as the content of the first media, and a resolution of the third media is lower than the resolution supported by the media playback device 93.

In this embodiment of the present invention, a control point controls a media playback device to play a first media, where the control point acquires a resolution supported by the media playback device; acquires, according to the resolution supported by the media playback device, address information of the first media to be sent to the media playback device; and sends the address information of the first media to the media playback device, so that the media playback device plays the first media according to the address information of the first media. This embodiment of the present invention is advantageous because the control point can select, according to the resolution supported by the media playback device, a media resource of a corresponding resolution, and push the media resource of the corresponding resolution to the media playback device. In this way, a media resource of a suitable resolution is dynamically selected, thereby exploiting a device playback capability and improving device playback quality.

Further, when there does not exist the first media whose resolution is the same as a highest resolution supported by the media playback device, address information of a third media is sent to the media playback device, so that the media playback device plays the third media according to the address information of the third media. In this way, when a media resource with a relatively high resolution does not exist, a media resource with a lower resolution can be selected, which increases the probability of the media playback being successful, exploits a device playback capability, and improves device playback quality.

Further, when a network bandwidth of the media playback device is less than a network bandwidth required to play the first media, address information of a second media is sent to the media playback device, so that the media playback device plays the second media. In this way, when the network bandwidth is insufficient to play a media resource with a relatively high resolution, a media resource with a lower resolution can be selected, which increases the probability of the media playback being successful, exploits a device playback capability, and improves device playback quality.

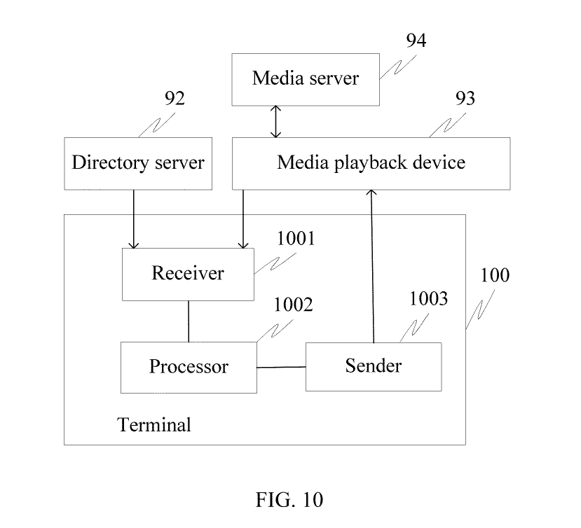

Refer to FIG. 10, which is a schematic structural diagram of another terminal 100 according to an embodiment of the present invention. The terminal 100 communicatively connects with both a directory server 92 and a media playback device 93, and the media playback device 93 communicatively connects with a media server 94. The terminal 100 controls the media playback device 93 to play a first media. The terminal 100 acquires a resolution supported by the media playback device 93; and acquires, according to the resolution supported by the media playback device 93, address information of the first media to be sent to the media playback device 93, where the media playback device 93 supports a resolution of the first media; and the terminal 100 sends the address information of the first media to the media playback device 93, so that the media playback device 93 plays the first media according to the address information of the first media. The terminal 100 includes a receiver 1001 configured to receive capability information of the media playback device 93; a processor 1002 configured to parse the capability information of the media playback device 93 to acquire the resolution supported by the media playback device 93; and acquire, according to the resolution supported by the media playback device 93, the address information of the first media to be sent to the media playback device 93, where the media playback device 93 supports the resolution of the first media; and a sender 1003 configured to send the address information of the first media to the media playback device 93, so that the media playback device 93 plays the first media according to the address information of the first media.

Further, the receiver 1001 is configured to acquire media description information from the directory server, where the media description information includes resolution information and address information of a media whose content is the same as content of the first media; and the processor 1002 is configured to determine, according to the resolution supported by the media playback device 93 and resolution information in the media description information, the first media whose resolution is the same as the resolution supported by the media playback device 93, and acquire the address information of the first media from the media description information.

Alternatively, further, the sender 1003 is configured to send the resolution supported by the media playback device 93 to the directory server, so that the directory server determines the first media that is to be pushed to the media playback device 93 and whose resolution is the same as the resolution supported by the media playback device 93; and the receiver 1001 is further configured to receive the address information of the first media from the directory server.

Further, the control point includes a bandwidth comparing unit 914 configured to determine whether a network bandwidth of the media playback device 93 is less than a network bandwidth required to play the first media; and the sender 1003 is further configured to, when the network bandwidth of the media playback device 93 is less than the network bandwidth required to play the first media, send address information of a second media to the media playback device 93, so that the media playback device 93 plays the second media, where content of the second media is the same as the content of the first media, and a network bandwidth required to play the second media is less than or equal to the network bandwidth of the media playback device 93.

Further, the sender 1003 is configured to, if there does not exist the first media whose resolution is the same as the resolution supported by the media playback device 93, send address information of a third media to the media playback device 93, so that the media playback device 93 plays the third media according to the address information of the third media, where content of the third media is the same as the content of the first media, and a resolution of the third media is lower than the resolution supported by the media playback device 93.

In this embodiment of the present invention, a terminal controls a media playback device to play a first media, where the terminal acquires a resolution supported by the media playback device; acquires, according to the resolution supported by the media playback device, address information of the first media to be sent to the media playback device; and sends the address information of the first media to the media playback device, so that the media playback device plays the first media according to the address information of the first media. This embodiment of the present invention is advantageous because the terminal can select, according to the resolution supported by the media playback device, a media resource of a corresponding resolution, and push the media resource of the corresponding resolution to the media playback device. In this way, a media resource of a suitable resolution is dynamically selected, thereby exploiting a device playback capability and improving device playback quality.

Further, when there does not exist the first media whose resolution is the same as a highest resolution supported by the media playback device, address information of a third media is sent to the media playback device, so that the media playback device plays the third media according to the address information of the third media. In this way, when a media resource with a relatively high resolution does not exist, a media resource with a lower resolution can be selected, which increases the probability of the media playback being successful, exploits a device playback capability, and improves device playback quality.

Further, when a network bandwidth of the media playback device is less than a network bandwidth required to play the first media, address information of a second media is sent to the media playback device, so that the media playback device plays the second media. In this way, when the network bandwidth is insufficient to play a media resource with a relatively high resolution, a media resource with a lower resolution can be selected, which increases the probability of the media playback being successful, exploits a device playback capability, and improves device playback quality.

Moreover, the technologies, systems, apparatus, methods, and technical features described separately in the embodiments may be combined to form another module, method, apparatus, system, or technology without departing from the spirit and principle of the present invention, and the another module, method, apparatus, system, and technology which are combined from the embodiments of the present invention shall fall within the protection scope of the present invention.

A person skilled in the art should appreciate that the units or steps in the present invention may be implemented by a general-purpose computer apparatus, and they may be co-located on a single computer apparatus or distributed on a network included of multiple computer apparatuses. Optionally, they may be implemented by executing program code on a computer apparatus so that they may be stored in a storage apparatus and executed by a computer apparatus. Alternatively, they are separately manufactured into circuit modules, or multiple units or steps in them are manufactured into a single circuit module to perform implementation. In this way, the present invention is not limited to any specific combination of hardware and software.

The foregoing descriptions are merely exemplary embodiments of the present invention, but are not intended to limit the protection scope of the present invention. Any modification, equivalent replacement, or improvement made without departing from the spirit and principle of the present invention shall fall within the protection scope of the present invention.

What is claimed is:

1. A media playback method, wherein the method is used to push a second media to a second device when a first device plays a first media, wherein the first device and the second device are in a same local area network, and wherein the method comprises:
acquiring, by the first device, a resolution supported by the second device;
acquiring, by the first device according to the resolution supported by the second device, address information of the second media to be sent to the second device, wherein content of the second media is the same as content of the first media, and the second device supports a resolution of the second media; and
sending, by the first device, the address information of the second media to the second device such that the second device plays the second media according to the address information of the second media.

2. The method according to claim 1, wherein acquiring, by the first device according to the resolution supported by the second device, the address information of the second media to be sent to the second device comprises:
acquiring, by the first device, media description information from a directory server, wherein the media description information comprises resolution information and address information of a media whose content is the same as the content of the first media;
determining, by the first device according to the resolution supported by the second device and resolution information in the media description information, a media whose resolution is the same as a highest resolution supported by the second device to be the second media; and
acquiring the address information of the second media from the media description information.

3. The method according to claim 1, wherein acquiring, by the first device according to the resolution supported by the second device, the address information of the second media to be sent to the second device comprises:
sending, by the first device, the resolution supported by the second device to a directory server such that the directory server determines a media whose resolution is the same as a highest resolution supported by the second device to be the second media that is to be pushed to the second device; and
receiving, by the first device, the address information of the second media from the directory server.

4. The method according to claim 1, wherein when a network bandwidth of the second device is less than a network bandwidth required to play the second media, address information of the first media is sent to the second device, so that the second device plays the first media, or address information of a third media is sent to the second device such that the second device plays the third media, wherein content of the third media is the same as the content of the first media, and a network bandwidth required to play the third media is less than or equal to the network bandwidth of the second device.

5. The method according to claim 2, wherein when there does not exist the second media whose resolution is the same as the highest resolution supported by the second device, address information of a fourth media is sent to the second device such that the second device plays the fourth media according to the address information of the fourth media, wherein content of the fourth media is the same as the content of the first media, and a resolution of the fourth media is lower than the highest resolution supported by the second device.

6. The method according to claim 1, wherein the method further comprises sending, by the first device to the second device, information about a current playback progress where the first device stops playing the first media such that the second device starts to play the second media, the first media, the third media, or the fourth media from where the current playback progress stops.

7. The method according to claim 6, wherein the information about the current playback progress where the first device stops playing the first media comprises a current timestamp of the first-media playback by the first device.

8. A media playback method, wherein the method is used by a control point to control a media playback device to play a first media, and wherein the method comprises:
acquiring, by the control point, a resolution supported by the media playback device;
acquiring, by the control point according to the resolution supported by the media playback device, address information of the first media to be sent to the media playback device, wherein the media playback device supports a resolution of the first media; and
sending, by the control point, the address information of the first media to the media playback device such that the media playback device plays the first media according to the address information of the first media.

9. The method according to claim 8, wherein acquiring, by the control point according to the resolution supported by the media playback device, the address information of the first media to be sent to the media playback device comprises:
acquiring, by the control point, media description information from a directory server, wherein the media description information comprises resolution information and address information of a media whose content is the same as content of the first media;
determining, by the control point according to the resolution supported by the media playback device and resolution information in the media description information, a media whose resolution is the same as a highest resolution supported by the media playback device to be the first media; and
acquiring the address information of the first media from the media description information.

10. The method according to claim 8, wherein acquiring, by the control point according to the resolution supported by the media playback device, the address information of the first media to be sent to the media playback device comprises:
sending, by the control point, the resolution supported by the media playback device to a directory server such that the directory server determines a media whose resolution is the same as a highest resolution supported by the media playback device to be the first media that is to be pushed to the media playback device; and
receiving, by the control point, the address information of the first media from the directory server.

11. The method according to claim 8, wherein when a network bandwidth of the media playback device is less than a network bandwidth required to play the first media, address information of a second media is sent to the media playback device such that the media playback device plays the second media, wherein content of the second media is the same as the content of the first media, and a network bandwidth required to play the second media is less than or equal to the network bandwidth of the media playback device.

12. The method according to claim 9, wherein when there does not exist the first media whose resolution is the same as the highest resolution supported by the media playback device, address information of a third media is sent to the media playback device such that the media playback device plays the third media according to the address information of the third media, wherein content of the third media is the same as the content of the first media, and a resolution of the third media is lower than the highest resolution supported by the media playback device.

13. A control point, wherein the control point is configured to push a second media to a second device when a first device plays a first media, wherein the first device and the second device are in a same local area network, and wherein the control point comprises:
a receiving unit;
an acquiring unit; and
a sending unit,
wherein the receiving unit is configured to receive capability information of the second device,
wherein the acquiring unit is configured to parse the capability information of the second device to acquire a resolution supported by the second device, and acquire, according to the resolution supported by the second device, address information of the second media to be sent to the second device, wherein content of the second media is the same as content of the first media, and the second device supports a resolution of the second media, and
wherein the sending unit is configured to send the address information of the second media to the second device such that the second device plays the second media according to the address information of the second media.

14. The control point according to claim 13, wherein the receiving unit is further configured to acquire media description information from a directory server, wherein the media description information comprises resolution information and address information of a media whose content is the same as the content of the first media, and wherein the acquiring unit is configured to determine, according to the resolution supported by the second device and resolution information in the media description information, a media whose resolution is the same as a highest resolution supported by the second device to be the second media, and acquire the address information of the second media from the media description information.

15. The control point according to claim 13, wherein the sending unit is further configured to send the resolution supported by the second device to a directory server such that the directory server determines a media whose resolution is the same as a highest resolution supported by the second device to be the second media that is to be pushed to the second device, and wherein the receiving unit is further configured to receive the address information of the second media from the directory server.

16. The control point according to claim 13, wherein the control point further comprises a bandwidth comparing unit, wherein the bandwidth comparing unit is configured to determine whether a network bandwidth of the second device is less than a network bandwidth required to play the second media, wherein the sending unit is further configured to, when the network bandwidth of the second device is less than the network bandwidth required to play the second media, send address information of the first media to the second device such that the second device plays the first media, or send address information of a third media to the second device such that the second device plays the third media, wherein content of the third media is the same as the content of the first media, and a network bandwidth required to play the third media is less than or equal to the network bandwidth of the second device.

17. The control point according to claim 14, wherein the sending unit is further configured to, when there does not exist the second media whose resolution is the same as the highest resolution supported by the second device, send address information of a fourth media to the second device such that the second device plays the fourth media according to the address information of the fourth media, wherein content of the fourth media is the same as the content of the first media, and a resolution of the fourth media is lower than the highest resolution supported by the second device.

18. The control point according to claim 13, wherein the sending unit is further configured to send, to the second device, information about a current playback progress where the first device stops playing the first media such that the second device starts to play the second media, the first media, the third media, or the fourth media from where the current playback progress stops.

19. A control point, wherein the control point is configured to control a media playback device to play a first media, and wherein the control point comprises:
a receiving unit;
an acquiring unit; and
a sending unit,
wherein the receiving unit is configured to receive capability information of the media playback device,
wherein the acquiring unit is configured to parse the capability information of the media playback device to acquire a resolution supported by the media playback device, and acquire, according to the resolution supported by the media playback device, address information of the first media to be sent to the media playback device, wherein the media playback device supports a resolution of the first media, and
wherein the sending unit is configured to send the address information of the first media to the media playback device such that the media playback device plays the first media according to the address information of the first media.

20. The control point according to claim 19, wherein the receiving unit is further configured to acquire media description information from a directory server, wherein the media description information comprises resolution information and address information of a media whose content is the same as content of the first media, and wherein the acquiring unit is configured to determine, according to the resolution supported by the media playback device and resolution information in the media description information, a media whose resolution is the same as a highest resolution supported by the media playback device to be the first media, and acquire the address information of the first media from the media description information.

21. The control point according to claim 19, wherein the sending unit is further configured to send the resolution supported by the media playback device to a directory server such that the directory server determines a media whose resolution is the same as a highest resolution supported by the media playback device to be the first media that is to be pushed to the media playback device and, wherein the receiving unit is further configured to receive the address information of the first media from the directory server.

22. The control point according to claim 19, wherein the control point further comprises a bandwidth comparing unit, wherein the bandwidth comparing unit is configured to determine whether a network bandwidth of the media playback device is less than a network bandwidth required to play the first media, and wherein the sending unit is further configured to, when the network bandwidth of the media playback device is less than the network bandwidth required to play the first media, send address information of a second media to the media playback device such that the media playback device plays the second media, wherein content of the second media is the same as the content of the first media, and a network bandwidth required to play the second media is less than or equal to the network bandwidth of the media playback device.

23. The control point according to claim 20, wherein the sending unit is further configured to, when there does not exist the first media whose resolution is the same as the highest resolution supported by the media playback device, send address information of a third media to the media playback device such that the media playback device plays the third media according to the address information of the third media, wherein content of the third media is the same as the content of the first media, and a resolution of the third media is lower than the highest resolution supported by the media playback device.

24. A terminal, wherein the terminal is configured to control a media playback device to play a first media, and wherein the terminal comprises:
a receiver;
a processor; and
a sender,
wherein the receiver is configured to receive capability information of the media playback device,
wherein the processor is configured to parse the capability information of the media playback device to acquire a resolution supported by the media playback device, and acquire, according to the resolution supported by the media playback device, address information of the first media to be sent to the media playback device, wherein the media playback device supports a resolution of the first media, and
wherein the sender is configured to send the address information of the first media to the media playback device such that the media playback device plays the first media according to the address information of the first media.

25. The terminal according to claim 24, wherein the receiver is further configured to acquire media description information from a directory server, wherein the media description information comprises resolution information and address information of a media whose content is the same as content of the first media, and wherein the processor is configured to determine, according to the resolution supported by the media playback device and resolution information in the media description information, a media whose resolution is the same as a highest resolution supported by the media playback device to be the first media, and acquire the address information of the first media from the media description information.

26. The terminal according to claim 24, wherein the sender is further configured to send the resolution supported by the media playback device to a directory server such that the directory server determines a media whose resolution is the same as a highest resolution supported by the media playback device to be the first media that is to be pushed to the media playback device, and wherein the receiver is further configured to receive the address information of the first media from the directory server.

27. The terminal according to claim 24, wherein the processor is further configured to determine whether a network bandwidth of the media playback device is less than a network bandwidth required to play the first media, and wherein the sender is further configured to, when the network bandwidth of the media playback device is less than the network bandwidth required to play the first media, send address information of a second media to the media playback device such that the media playback device plays the second media, wherein content of the second media is the same as the content of the first media, and a network bandwidth required to play the second media is less than or equal to the network bandwidth of the media playback device.

28. The terminal according to claim 25, wherein the sender is further configured to, when there does not exist the first media whose resolution is the same as the highest resolution supported by the media playback device, send address information of a third media to the media playback device such that the media playback device plays the third media according to the address information of the third media, wherein content of the third media is the same as the content of the first media, and a resolution of the third media is lower than the highest resolution supported by the media playback device.

29. The terminal according to claim 24, wherein the terminal is a smartphone, a tablet computer, a personal computer, or a smart television.
